(19) United States
(12) Patent Application Publication
(10) Pub. No.: US 2022/0376260 A1
(43) Pub. Date: Nov. 24, 2022

(54) POLYVINYL PYROLLIDONE AS A DISPERSANT FOR LITHIUM ION BATTERY CATHODE PRODUCTION

(71) Applicant: Dow Global Technologies LLC, Midland, MI (US)

(72) Inventors: Peng Gao, Shanghai (CN); Tao Wang, Shanghai (CN); Qi Jiang, Shanghai (CN); Xin Jiang, Shanghai (CN)

(73) Assignee: Dow Global Technologies LLC, Midland, MI (US)

(21) Appl. No.: 17/432,414

(22) PCT Filed: Apr. 26, 2019
(86) PCT No.: PCT/CN2019/084562

§ 371 Date: Aug. 19, 2021

(51) Int. Cl. H01M 4/62; H01M 4/58; H01M 4/04; H01M 10/0525

(52) U.S. Cl. CPC H01M 4/623; H01M 4/625; H01M 4/5825; H01M 4/04; H01M 10/0525; H01M 2004/028

(57) ABSTRACT

The process of making a lithium ion battery cathode comprises the step of forming a slurry of an active material, a nano-size conductive agent, a binder polymer, a solvent and a dispersant. The solvent consists essentially of one or more of a compound of Formula 1 and optionally, one or more of N, N-dimethylacetoacetamide, N, N-diethylacetoacetamide, γ-valerolactone, and triethyl phosphate, and the dispersant comprises polyvinyl pyrrolidone.

### FIELD

This invention relates to the production of lithium ion batteries. In one aspect the invention relates to the production of the cathode of such batteries while in another aspect, the invention relates to the materials used in the production of such cathodes.

### BACKGROUND

The significant growth of electrical vehicles and portable electronic devices have led to an increase in the demand for rechargeable, also known as secondary, batteries, especially the various types of lithium ion batteries. Modern trends of small size and light weight require that these rechargeable batteries have not only a high energy density, but are also environmentally friendly. The eco-friendly requirements apply not only to the battery product itself, but also to the production process by which it is made.

The cathode component of a lithium ion battery is made by forming a slurry from an active material (e.g., lithium cobalt oxide, lithium iron phosphate, etc.), and a binder polymer (e.g., polyvinylidene fluoride (PVDF)), dissolved in a solvent, coating the slurry onto an aluminum foil, and drying the coated foil to remove the solvent. The conductivity of the cathode is always a target for improvement and to this end, lithium ion battery manufacturers have added conductive agents to the mix. These agents (e.g., carbon black), form part of the slurry that is applied to the aluminum foil. Besides their good conductivity, these conductive agents are characterized by low gravity, stable structure and good chemical resistance.

Generally, the smaller the size of conductive agent, the better the conductivity. Nano-size particles are well known to have a very high surface area and surface energy but because of these properties, they aggregate easily or, in other words, they are difficult to disperse. If the nano-size conductive agent particles are not well dispersed within the cathode, then their boost to cathode conductivity is muted.

In order to disperse the nano-size conductive agents and stabilize them in the cathode materials of the slurry formulation, a strong repelling force between the nano-size conductive agent particles is required. The traditional way to achieve this end is to use a static electricity mechanism to change the particle surface electric charge density and type. However, this method requires a high dosage level of dispersant.

### SUMMARY

In one embodiment the present disclosure provides a process of making a lithium ion battery cathode, the process comprising the step of forming a slurry of an active material, a nano-size conductive agent, a binder polymer, a solvent and a dispersant,

the solvent consisting essentially of one or more of a first compound of Formula 1

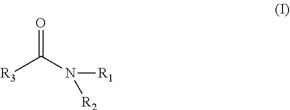

in which R₁ and R₂ are hydrogen or a C1-4 straight or branched chain alkyl or alkoxy, and R₃ is a C1-10 straight or branched chain alkyl or alkoxy, with the proviso that R₁ and R₂ are not both hydrogen; and optionally, one or more of N,N-dimethylacetoacetamide, N,N-diethylacetoacetamide, γ-valerolactone, and triethyl phosphate; and the dispersant comprises polyvinyl pyrollidone.

In some embodiments, the use of polyvinyl pyrrolidone (“PVP”) as a dispersant in combination with the solvent of Formula 1 (and optionally, in combination with one or more of N,N-dimethylacetoacetamide, N,N-diethylacetoacetamide, γ-valerolactone, and triethyl phosphate) provides a number of advantages. In particular, the PVP can advantageously dissolve quickly in the solvent and disperse the nano-size conductive agent to enable good cathode coating, while advantageously avoiding the generation of foam.

### BRIEF DESCRIPTION OF THE DRAWINGS

FIG. 1 is a block flow diagram describing a conventional production process for making a lithium ion battery in which NMP is used as the solvent in the formation of cathode and anode slurries from an active material, conductive agent, binder and dispersant.

FIG. 2 is a collection of micrographs showing the appearance of SUPER P conductive carbon black in different dispersants.

### DETAILED DESCRIPTION

### Definitions

For purposes of United States patent practice, the contents of any referenced patent, patent application or publication are incorporated by reference in their entirety (or its equivalent U.S. version is so incorporated by reference) especially with respect to the disclosure of definitions (to the extent not inconsistent with any definitions specifically provided in this disclosure) and general knowledge in the art.

The numerical ranges disclosed herein include all values from, and including, the lower and upper value. For ranges containing explicit values (e.g., 1 to 7), any subrange between any two explicit values is included (e.g., 1 to 2; 2 to 6; 5 to 7; 3 to 7; 5 to 6; etc.).

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

Unless stated to the contrary, implicit from the context, or customary in the art, all parts and percents are based on weight and all test methods are current as of the filing date of this disclosure.

“Active material” and like terms mean, as used in the context of a lithium ion battery, a substance that is either the source of lithium ions or that can receive and accept lithium ions. In the context of the cathode of a lithium ion cell, the active material is the source of the lithium ions, e.g., lithium cobalt oxide, lithium manganese oxide, etc. In the context of the anode of a lithium ion cell, the active material is the receptor of the lithium ions, e.g., graphite. The active materials are typically in the form of very small particles having a diameter from 1000 nanometers to 100 micrometers.

“Alkoxy” refers to the —OZ¹ radical, where representative Z¹ include alkyl, substituted alkyl, cycloalkyl, substituted cycloalkyl, heterocycloalkyl, substituted heterocycloalkyl, silyl groups and combinations thereof. Suitable alkoxy radicals include, for example, methoxy, ethoxy, benzyloxy, t-butoxy, etc. A related term is “aryloxy” where representative Z¹ include aryl, substituted aryl, heteroaryl, substituted heteroaryl, and combinations thereof. Examples of suitable aryloxy radicals include phenoxy, substituted phenoxy, 2-pyridinoxy, 8-quinalinoxy and the like.

“Alkyl” refers to a saturated linear, cyclic, or branched hydrocarbon group. Nonlimiting examples of suitable alkyl groups include, for example, methyl, ethyl, n-propyl, i-propyl, n-butyl, t-butyl, i-butyl (or 2-methylpropyl), etc. In one embodiment, the alkyls have 1 to 20 carbon atoms.

“Anode” and like terms, as used in the context of a lithium ion battery, mean the negative electrode in the discharge cycle. The anode is the electrode where oxidation takes place within the battery during discharge, i.e., electrons are freed and flow out of the battery.

“Battery” and like terms mean a collection of cells or cell assemblies which are ready for use. A battery typically contains an appropriate housing, electrical interconnections, and, possibly, electronics to control and protect the cells from failure, e.g., fire, thermal runaway, explosion, loss of charge, etc. The simplest battery is a single cell. Batteries can be primary, i.e., non-rechargeable, and secondary, i.e., rechargeable.

“Binder polymers” and like terms mean, as used in the context of a lithium ion battery, a polymer that holds the active material particles within an electrode of a lithium-ion battery together to maintain a strong connection between the electrode and the contacts. Binder polymers are normally inert to the substances in which they are in contact within the lithium ion battery during discharging, charging and storage.

“Cathode” and like terms, as used in the context of a lithium ion battery, mean the positive electrode in the discharge cycle. The lithium in a lithium ion battery is in the cathode. The cathode is the electrode where reduction takes place within the battery during discharge.

“Cell” and like terms mean a basic electrochemical unit that contains electrodes, separator, and electrolyte.

“Conductive agent” and like terms mean, as used in the context of a lithium ion battery, a substance that promotes the flow of ions between the electrodes of a cell. Carbon-based compounds and materials, e.g., acetylene black, carbon nano-tubes, carbon-based polymers, and the like, are typical conductive agents used in lithium ion batteries.

“Dispersant” and like terms mean a substance added to a suspension, usually a colloid, to improve the separation of particles and to prevent settling or clumping. Dispersants consist normally of one or more surfactants.

“Electrolyte” and like terms mean, as used in the context of a lithium ion battery, a substance that carries positively charged lithium ions from the anode to the cathode, and vice versa, through a separator.

“Lithium ion battery” and like terms mean a rechargeable, i.e., secondary, battery in which lithium ions move from the negative electrode to the positive electrode during discharge and back when charging. Lithium ion batteries use an intercalated lithium compound as one electrode material as opposed to the metallic lithium used in a non-rechargeable lithium battery (also known as a primary battery). The electrolyte, which allows for ionic movement, and the two electrodes are the constituent components of a lithium-ion battery cell.

“Nano” means one-billionth (10⁻⁹). “Nano-size particle” and like terms mean a particle of a size, e.g., diameter, length/width/depth, etc., that is conventionally measured in billionths. Nano-size particles include particles that are smaller or larger than one-billionth, e.g., particle sizes up to one-millionth and down to one pico.

“Separator” and like terms mean, as used in the context of a lithium ion battery, a thin, porous membrane that physically separates the anode and cathode. The primary function of the separator is to prevent physical contact between the anode and cathode, while facilitating lithium ion transport within the cell. Separators are typically a simple plastic film, e.g., polyethylene or polypropylene, or a ceramic, with a pore size designed to allow lithium ion transit.

“Solvent” and like terms mean a substance that is capable of dissolving another substance (i.e., a solute) to form an essentially uniformly dispersed mixture (i.e., solution) at the molecular or ionic size level.

### Production Process for Lithium Ion Battery

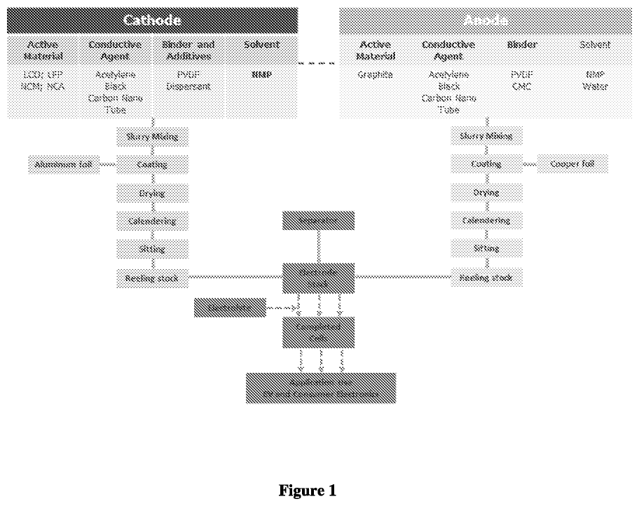

FIG. 1 shows a conventional production process flow diagram for a lithium ion battery in which NMP is used as a solvent. NMP is used as the solvent to dissolve binder polymers like polyvinylidene fluoride (PVDF) which is then used to form a slurry of active material, conductive agent, dispersant and other additives. Conductive agents include, but are not limited to, carbon black, carbon nano-tubes, graphene, nano-graphite, and/or fullerene. Active materials include but are not limited to lithium cobalt oxide (LiCoO₂), lithium manganese oxide (LiMn₂O₄), lithium nickel manganese cobalt oxide (LiNiMnCoO₂ or NMC), lithium iron phosphate (LiFePO₄), lithium nickel cobalt aluminum oxide (LiNiCoAlO₂), and lithium titanate (Li₄Ti₅O₁₂). The slurry is then coated onto a foil, typically aluminum for the cathode and copper for the anode, and the coated foil then dried.

In the drying process (typically in an oven), NMP is evaporated without residue, and the dried foil comprises a fine film having a thickness from 50 micrometers to 200 micrometers and including a solid component which is the dried slurry comprising the binder polymers, active material, conductive agent, dispersant and other additives. The dried foil is then calendared in a calendar machine, allowed to set, and then collected on a reel. Eventually the cathode and anode films are combined into an electrode stack and the cell is completed with the addition of electrolyte.

### Conductive Agent

Any nano-size conductive agent can be used in the practice of embodiments of this disclosure. Typically the conductive agent is a nano-size carbon black, e.g., an acetylene black, carbon nano-tubes, carbon nano-fibers, graphene, nano-graphite, etc. In some embodiments, the nano-size conductive agent has a mean particule size of 1.2 microns or less. The nano-size conductive agent has a mean particle size of 1.0 micron or less in some embodiments. SUPER P conductive carbon black available from TIMCAL™ Graphite and Carbon is an example of a commercially available conductive agent that can be used in the practice of embodiments of this disclosure. SUPER P conductive carbon black has a mean particle size of approximately 1 micron.

### Dispersant

The dispersant used in the practice of embodiments of this disclosure is polyvinyl pyrrolidone, the structure of which is:

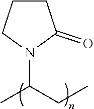

in which n is from 100 to 10,000. In some embodiments, n in the above structure is from 300 to 3,000. The dispersant can be a single PVP species, e.g., of one molecular weight, or a mixture of PVPs differing in molecular weight. The PVP has a molecular weight of 3,000 to 400,000 in some embodiments, 10,000 to 200,000 in other embodiments, and 30,000 to 60,000 in other embodiments. Non-limiting examples of commercially available PVP include PVP K-15, PVP K-30, PVP K-60 and others which are commercially available from a variety of suppliers. In some embodiments where the solvent used in the slurry is DMPA, the amount of PVP in the slurry can be 0.01 to 5 weight percent, or 0.1 to 2 weight percent, or 0.3 to 1 weight percent (each based on the total weight of the slurry).

The dispersant can consist of only PVP (preferred), or it can comprise PVP in combination with one or more other dispersants, e.g., polyethylene glycol, and other nonionic and anionic surfactants. If mixed with one or more other dispersants, PVP typically comprises at least 50, or 55, or 60, or 65, or 70, or 75, wt % of the dispersant mixture. In some embodiments where other dispersants are used with PVP, the mixture of dispersants does not include ethyl cellulose. In some embodiments where other dispersants are used with PVP, the mixture of dispersants comprises less than 1 wt % ethyl cellulose, or less than 0.1 wt % ethyl cellulose, or less than 0.01 wt % ethyl cellulose (each based on the weight of the dispersant mixture).

### Solvents

The solvent used in the practice of embodiments of this disclosure is a replacement solvent for NMP in lithium ion battery production processes such as shown in FIG. 1. This solvent consists of, or consists essentially of, one or more of a compound of Formula 1, and, optionally, one or more of N,N-dimethylacetoacetamide, N,N-diethylacetoacetamide, γ-valerolactone, and triethyl phosphate. In one embodiment the solvent consists of only one of any compound of Formula 1. In one embodiment, the solvent consists of N,N-dimethylpropionamide (DMPA). In those embodiments in which the solvent consists of Formula 1, or of two or more compounds of Formula 1, or of a compound of Formula 1 and one or more of N,N-dimethylacetoacetamide, N,N-diethylacetoacetamide, γ-valerolactone, and triethyl phosphate, the amount of any one of the compounds in the mixture can range from 1 to 99, or 10 to 90, or 20 to 80, or 30 to 70, or 40 to 60, weight percent (wt %) of the weight of the mixture. In one embodiment each solvent in the mixture of solvents is present in an amount within 20, or 15, or 10, or 5, or 3, or 1, wt % of each of the other solvents in the mixture.

In one embodiment the solvent used in the practice of this invention consists of a compound of Formula 1. In one embodiment the solvent used in accordance with embodiments of the present disclosure consists of two or more compounds of Formula 1

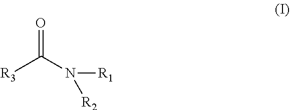

in which R₁ and R₂ are hydrogen or a C1-4 straight or branched chain alkyl or alkoxy, and R₃ is a C1-10 straight or branched chain alkyl or alkoxy, with the proviso that R₁ and R₂ are not both hydrogen.

In one embodiment, the solvent comprising compounds of Formula 1 is one or more of N,N-dimethylpropionamide (DMPA); 3-methoxy-N,N-dimethylpropanamide (M3DMPA); N,N-dimethylbutyramide; N,N-dimethylvaleramide; N,N diethylpropionamide; N,N dipropylpropionamide; N,N dibutylpropionamide; N,N dimethylethylpropionamide; 3-butoxy-N-methyl propionamide; and N,N-diethyl acetamide (DEAC). In one embodiment the compound of Formula 1 is DMPA.

In some embodiments, the solvent used in the practice of this invention comprises at least one additional compound in addition to the solvent according to Formula 1. Examples of solvents that can be blended with the solvent according to Formula 1 include N,N-dimethylacetoacetamide (DMAA), N,N-diethylacetoacetamide (DEAA), γ-valerolactone, triethyl phosphate (TEP), and mixtures thereof.

The individual solvents used in the practice of this invention are known compounds, liquid at ambient conditions (23° C. and atmospheric pressure), and generally commercially available. To form a mixture of two or more solvents (e.g., two or more solvents of Formula 1; or a solvent of Formula 1 and one or more of DMAA, DEAA, and TEP), the individual solvents can simply be mixed with one another using conventional mixing equipment and standard blending protocols. The individual solvents can be added to one another in any order including simultaneously.

In one embodiment the solvents are intended as a replacement for NMP in the production process for lithium ion batteries. As such, they are used in the same manner as NMP in such processes (e.g. such as the process shown in FIG. 1). Typically, this process includes the steps of dissolving the binder polymer with the solvent, and then forming a slurry from the dissolved binder, an active material, a conductive agent and a dispersant. The slurry is then applied to a foil, and the foil dried during which the solvent is removed by evaporation.

The solvents used in the practice of embodiments of the present disclosure can dissolve the binder polymer faster than NMP, which, in turn, can improve the production efficiency of the batteries. The binder polymer solutions based on the solvents used in embodiments of the present disclosure also show a lower viscosity than the binder polymer solutions based on NMP, which, in turn, also improves the production efficiency of the batteries. Moreover, some of the solvents used in the embodiments of the present disclosure have lower boiling points and higher evaporation rates than NMP which means that they can be evaporated faster with lower energy consumption and leave less residue. As NMP is typically recycled, the solvents disclosed herein are easier to recycle due to their lower boiling point and higher evaporation rate, an overall cost saving for the battery production process.

In one embodiment the disclosure provides a process of making a cathode for use in a lithium ion battery in which one or more of a compound of Formula 1 (or a compound of Formula 1 and one or more of is used as the solvent for the binder polymer and polyvinyl pyrollidone is the dispersant for the nano-size conductive agent. This combination of solvents and dispersant produces a good dispersion of conductive agents, strong dissolving capability for PVDF, shorter time for dissolution, and lower viscosity. These benefits bring value to lithium ion battery producers for enhancing production efficiency and lowering the manufacturing cost.

By way of example, and not limitation, some embodiments of the present disclosure will now be described in detail in the following Examples.

### EXAMPLES

### Materials

The solvents are N-methyl-2-pyrrolidone (NMP) (Sinopharma, 99%) and N,N-dimethylpropionamide (DMPA) (Xingxin, 98%). All solvent samples are treated with a 4 A dehydrated molecular sieve (from Sigma-Aldrich) for more than 2 days to remove water.

The nano-size conductive agent is SUPER P conductive carbon black available from TIMCAL™ Graphite and Carbon.

The dispersants are ETHOCEL™ Std. 100 ethyl cellulose from The Dow Chemical Company and PVP K-30 polyvinyl pyrrolidone (PVP) from Sinopharm Chemical Reagent Col. Ltd. The dispersants are dehydrated in a 60° C. oven for at least two hours prior to use.

The binder is Kynar 761A poly(vinylidene fluoride) (PVDF) from Arkema Group. The PVDF is dehydrated in a 80° C. oven for at least two hours prior to use.

The cathode material is Lithium Iron Phosphate (LiFePO₄ or LFP) from China Aviation Lithium Battery Co., Ltd. The cathode material is dehydrated in a 80° C. oven for more than 2 hours before use.

### Example 1

In this Example, the time for dissolving the dispersants in a DMPA solvent are measured. 0.2 grams of the specified dispersant and 19.8 grams of DMPA are added in a vial which is then sealed with a cap. The vial is secured in a SPEEDMIX™ DAC 150.1 FVZ-k mixer and mixed at 2000 rpm. During mixing, this mixer is stopped every 2 minutes for cooling and to determine if all of the dispersant has dissolved. The time at which all of the dispersant in the vial has dissolved is recorded. The different samples and the results are shown in Table 1.

TABLE 1

| | | Time to Dissolve |
|---|---|---|
| Sample | Composition | (minutes) |
| Comparative Example A | 1 wt. % ethyl | 28 |
| | cellulose in DMPA | |
| Comparative Example B | 2 wt. % ethyl | 52 |
| | cellulose in DMPA | |
| Comparative Example C | 3 wt. % ethyl | 66 |
| | cellulose in DMPA | |
| Inventive Example 1 | 1 wt. % PVP in DMPA | 4 |
| Inventive Example 2 | 2 wt. % PVP in DMPA | 6 |
| Inventive Example 3 | 3 wt. % PVP in DMPA | 8 |

Foaming of these solutions would be undesirable. After mixing, Comparative Example A and Inventive Example 1 are manually shaken for 30 seconds to assess foaming. Comparative Example A generated a stable foam (having a height of less than 1 centimeter) which lasted for more than 30 minutes. In contrast, Inventive Example 1 did not generate a foam bubble even after vigorous shaking.

### Example 2

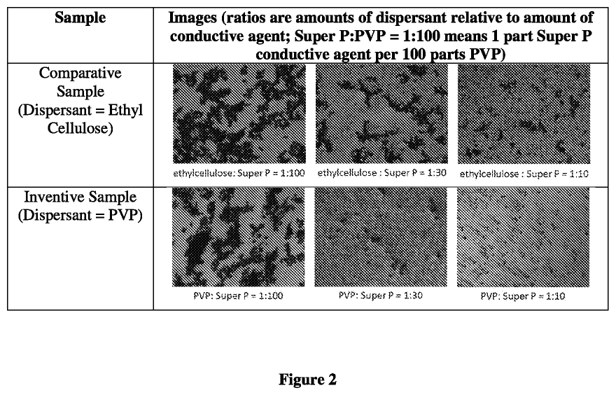

In this Example, the dispersing performance of the two dispersants are evaluated. The specified amount of conductive agent (Super P conductive carbon black) is weighed in a vial. The solvent with the specified dispersant dissolved therein is added. The vial is sealed with a cap and mixed in a SPEEDMIX™ DAC 150.1 FVZ-k mixer at 3000 rpm for 3 minutes, and then repeated for another 3 minutes. After mixing, the conductive agent dispersion is cast on a slide glass to observe if the conductive agent particles are agglomerated or dispersed. A LEICA DM2500 M microscope is used to observe the appearance of the solution and take micrographs. FIG. 2 shows the appearance of the conductive agent in two dispersants at different concentrations. As shown in FIG. 2, the conductive agent disperses a little better in DMPA when PVP is used as a dispersant relative to using ethyl cellulose as a dispersant.

### Example 3

For this example, the performance of cathode slurries and coating performance are evaluated. Table 2 below shows the different cathode slurry formulations that are prepared. Each slurry formulation is prepared as follows.

First, a high concentration PVDF solution is prepared. The PVDF is transferred into a 3 neck flask and filled with solvent according to the concentration desired. After 10 minutes of purges by high quality N₂, an oil bath is heated to 60° C. and mixing is started at 60 rpm. After all solid or gel-like matters are totally dissolved, the equipment is stopped and the solution is transferred to clean and dry glass bottle for use.

Four different dispersions of conductive agents are prepared using a dispersant and solvent in accordance with the procedure described in Example 2.

Next, the cathode slurries are formulated by using the conductive agent dispersion, cathode material, PVDF solution, and solvent. The amounts of the components specified for a cathode slurry in Table 2 are added into a vial. The vial is sealed with a cap and mixed in a SPEEDMIX™ DAC 150-1FVZ-k mixer at 3000 rpm for 18 minutes. During this step, the mixer is stopped every 3 minutes for cooling. The viscosity of each cathode slurry is measured at 25° C. according to ASTM D562-2001 using a #63 spindle on a Brookfield DV1MLVTJ0 viscometer. The viscosities are shown in Table 2.

Next, 20 cm×30 cm samples of aluminum foil are cleaned with ethanol and dried for use as substrates for the cathode slurries. A manual draw-down blade with a gap of 150 microns is used to apply each cathode slurry onto an Al foil substrate. After draw-down application, the wet coating is moved to an oven with ventilation to dry. The drying temperature begins at 50° C. and is held at that temperature for 30 minutes. The temperature is then increased by 10° C. and held at that temperature for 30 minutes. These increases continue until a temperature of 100° C. is reached.

The coating surface morphology is characterized by high resolution to determine if the conductive agent is dispersed well. For each cathode slurry formulation, the slurry is coated onto four film samples. On each coated film sample, three locations are tested for electric resistance using a 4-probe tester to evaluate electric resistance. A total of twelve data points are collected, and the average electric resistance is reported in Table 2. In addition, two spots on four different samples of each cathode slurry formulation are tested for adhesion. The adhesion is measured in accordance with ASTM D-3359. These results are shown in Table 2.

TABLE 2

| | | Comparative | Comparative | Inventive | Inventive |
|---|---|---|---|---|---|
| | | Example D | Example E | Example 4 | Example 5 |
| Cathode | Cathode Material | 56.93% | 56.98% | 56.93% | 56.98% |
| slurry | (LFP) | | | | |
| formulation | Conductive Agent | 1.20% | 1.20% | 1.20% | 1.20% |
| | (Super P Carbon Black) | | | | |
| | Dispersant 1 | 0.12% | 0.04% | / | / |
| | (ethyl cellulose) | | | | |
| | Dispersant 2 (PVP) | / | / | 0.12% | 0.04% |
| | Binder (PVDF) | 1.80% | 1.80% | 1.80% | 1.80% |
| | Solvent (DMPA) | 39.95% | 39.98% | 39.95% | 39.98% |
| | Total | 100.00% | 100.00% | 100.00% | 100.00% |

| | | | | |
|---|---|---|---|---|
| Cathode slurry viscosity (cP) | 6983 | 6967 | 6887 | 6873 |
| Cathode coating thickness (um) | 50.3 | 51.2 | 50.8 | 50.3 |
| Cathode coating electric resistance | 104.8 | 93.6 | 94.2 | 95.7 |
| (Ohm) | | | | |
| Cathode coating adhesion (ASTM- | 4B | 4B | 4B | 4B |
| D-3359 | | | | |

As seen in the above Examples, the combination of PVP as a dispersant with DMPA is a solvent provides good dispersion of carbon black, good slurry viscosity, desirable cathode electric resistance, and desirable adhesion. In addition, PVP dissolves much more quickly in the solvent relative to ethyl cellulose dispersant while also avoiding foaming. This is beneficial for the manufacture of lithium ion batteries.

1. A process of making a lithium ion battery cathode, the process comprising the step of forming a slurry of an active material, a nano-size conductive agent, a binder polymer, a solvent and a dispersant,
the solvent consisting essentially of one or more of a compound of Formula 1 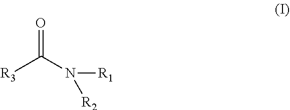
in which R₁ and R₂ are hydrogen or a C1-4 straight or branched chain alkyl or alkoxy, and R₃ is a C1-10 straight or branched chain alkyl or alkoxy, with the proviso that R₁ and R₂ are not both hydrogen; and
optionally, one or more of N,N-dimethylacetoacetamide, N,N-diethylacetoacetamide, γ-valerolactone, triethyl phosphate; and
the dispersant comprises polyvinyl pyrrolidone.

2. The process of claim 1, wherein the solvent consists of a compound of Formula 1.

3. The process of claim 2, wherein the solvent is N,N-dimethylpropionamide.

4. The process of claim 1, wherein the solvent consists of a compound of Formula 1 and at least one of N,N-dimethylacetoacetamide, N,N-diethylacetoacetamide, γ-valerolactone, and triethyl phosphate.

5. The process of claim 4, wherein the compound of Formula 1 is N,N-dimethylpropionamide.

6. The process of claim 1 in which the nano-size conductive agent is carbon black, carbon nano-tubes, graphene, or nano-graphite.

7. The process of claim 1 in which the binder polymer is polyvinylidene fluoride (PVDF).

8. The process of claim 1 in which the active material is one or more of lithium cobalt oxide (LiCoO₂), lithium manganese oxide (LiMn₂O₄), lithium nickel manganese cobalt oxide (LiNiMnCoO₂), lithium iron phosphate (LiFePO₄), lithium nickel cobalt aluminum oxide (LiNiCoAlO₂), and lithium titanate (Li₄Ti₅O₁₂).

9. A cathode made by the process of claim 1.

10. A lithium ion battery comprising the cathode of claim 9.
